(19) United States
(12) Patent Application Publication
(10) Pub. No.: US 2019/0369643 A1
(43) Pub. Date: Dec. 5, 2019

(54) AUTONOMOUS DRIVING SYSTEM

(71) Applicant: LG ELECTRONICS INC., Seoul (KR)

(72) Inventors: Soojung Jeon, Seoul (KR); Junyoung Yu, Seoul (KR); Daegeun Ha, Seoul (KR)

(21) Appl. No.: 16/545,645

(22) Filed: Aug. 20, 2019

(30) Foreign Application Priority Data
Jun. 17, 2019 (KR) 10-2019-0071813

(51) Int. Cl. G05D 1/02; B60W 30/182; G08G 1/01; G05D 1/00; B60W 40/04

(52) U.S. Cl. CPC G05D 1/0289; B60W 30/182; B60W 40/04; G05D 1/0061; G08G 1/0112

(57) ABSTRACT

There is disclosed an autonomous driving method, including: deriving surrounding environment information of a vehicle and traffic signal information that the vehicle is predicted to have faced, based on data received from at least one of a Vehicle to Everything (V2X) network and a vehicle sensor; determining whether or not it is possible to control driving of the vehicle by utilizing the surrounding environment information and the traffic signal information; displaying contents for receiving an input of a user, in a case where it is determined that it is not possible to control driving of the vehicle; and generating a driving control signal of the vehicle based on the input of the user, the surrounding environment information, and traffic signal information.

### CROSS-REFERENCE TO RELATED APPLICATION

This application is based on and claims priority under 35 U.S.C. § 119(a) to Korean Patent Application No. 10-2019-0071813, which was filed on Jun. 17, 2019, in the Korean Intellectual Property Office, the disclosure of which is incorporated herein in its entirety by reference.

### BACKGROUND

### 1. Field

The present disclosure relates to an autonomous driving system.

### 2. Description of the Related Art

The autonomous driving system refers to a system capable of recognizing an environment around a vehicle and a state of the vehicle, and controlling driving of the vehicle according to the environment and state. For autonomous driving, the vehicle uses data received through a V2X network or a sensor of the vehicle. At this time, in a case where data different from an actual surrounding environment of the vehicle is recognized as surrounding environment information of the vehicle or traffic signal information, an accuracy of the driving control of the autonomous driving system may decrease, or a risk of accidents may increase. In addition, since the control of the vehicle is transitioned from the autonomous driving system to a user, a convenience of the user may be reduced.

Therefore, when pieces of data received by the vehicle are inconsistent with each other, there is carried out research on an autonomous driving system and autonomous driving method, in which it is possible to continue autonomous driving by receiving a simple input of the user.

### SUMMARY

Disclosed embodiments intend to disclose an autonomous driving method and system in which autonomous driving of the vehicle is continued based on the input of the user. Technical problems to be dealt with by the embodiments are not limited to the aforementioned technical problems, and other technical problems may be inferred from the following embodiments.

According to an embodiment of the present invention, there is provided an autonomous driving method, including: deriving surrounding environment information of a vehicle and traffic signal information that the vehicle is predicted to have faced, based on data received from at least one of a Vehicle to Everything (V2X) network and a vehicle sensor; determining whether or not it is possible to control driving of the vehicle by utilizing the surrounding environment information and the traffic signal information; displaying contents for receiving an input of a user, in a case where it is determined that it is not possible to control driving of the vehicle; and generating a driving control signal of the vehicle based on the input of the user, the environment information, and traffic signal information.

According to an embodiment of the present invention, there is provided an autonomous driving system, including: a display configured to display contents for receiving an input of a user; a memory configured to store surrounding environment information of a vehicle and traffic signal information that the vehicle is predicted to have faced; and a processor configured to derive the surrounding environment information of the vehicle and the traffic signal information, based on data received from at least one of a V2X network and a vehicle sensor, to determine whether or not it is possible to control driving of the vehicle by utilizing the surrounding environment information and the traffic signal information, to control the display such that contents for receiving an input of a user are displayed on the display, in a case where it is determined that it is not possible to control driving of the vehicle, and to generate a driving control signal of the vehicle based on the input of the user, the environment information, and traffic signal information.

The specific matters of other embodiments are included in the detailed description and drawings.

According to an embodiment of the present invention, there is one or more of the following effects.

First, there is an effect that, in a case where the autonomous driving system is difficult to autonomously drive based on surrounding environment information and traffic signal information, the autonomous driving system may generate a driving control signal based on a simple input of a user to continue autonomous driving, thereby enhancing the convenience of the user.

Second, there is another effect that, in a case where the autonomous driving system is difficult to control driving based on pieces of information, the autonomous driving system may control driving depending on the input of the user, thereby improving the stability of autonomous driving.

The effects of the invention are not limited to the aforementioned effects, and other effects that have not been mentioned will be apparently understood by those skilled in the art from the description of the claims.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an AI device 100 according to an embodiment of the present disclosure.

FIG. 2 illustrates AI server 200 according to an embodiment of the present disclosure.

FIG. 3 illustrates an AI system 1 according to an embodiment of the present disclosure.

FIG. 4 is a view illustrating an example in which it is determined that an autonomous driving system according to an embodiment of the present invention is not capable of controlling the driving of the vehicle.

FIGS. 5A and 5B are views illustrating an example in which it is determined that an autonomous driving system according to another embodiment of the present invention is not capable of controlling the driving of the vehicle.

FIG. 6 is a view illustrating an example in which it is determined that an autonomous driving system according to still another embodiment of the present invention is not capable of controlling the driving of the vehicle.

FIG. 7 is a view illustrating an example in which it is determined that an autonomous driving system according to still other embodiments of the present invention is not capable of controlling the driving of the vehicle.

FIGS. 8A and 8B are views illustrating an example in which an autonomous driving system according to an embodiment of the present invention receives an input of a user.

FIGS. 9A and 9B are views illustrating an example in which an autonomous driving system according to another embodiment of the present invention receives an input of a user.

FIG. 10 is a block diagram of an autonomous driving system according to an embodiment of the present invention.

FIG. 11 is a flowchart illustrating an autonomous driving method according to an embodiment of the present invention.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Exemplary embodiments of the present invention are described in detail with reference to the accompanying drawings. Detailed descriptions of technical specifications well-known in the art and unrelated directly to the present invention may be omitted to avoid obscuring the subject matter of the present invention. This aims to omit unnecessary description so as to make clear the subject matter of the present invention. For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification. It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams. Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions. According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card. In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

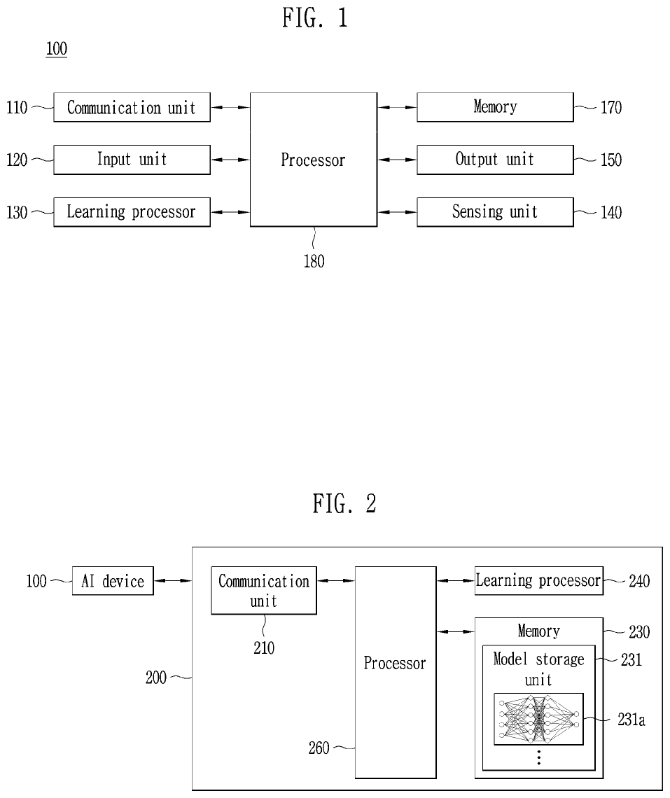

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), bluetoothTM, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

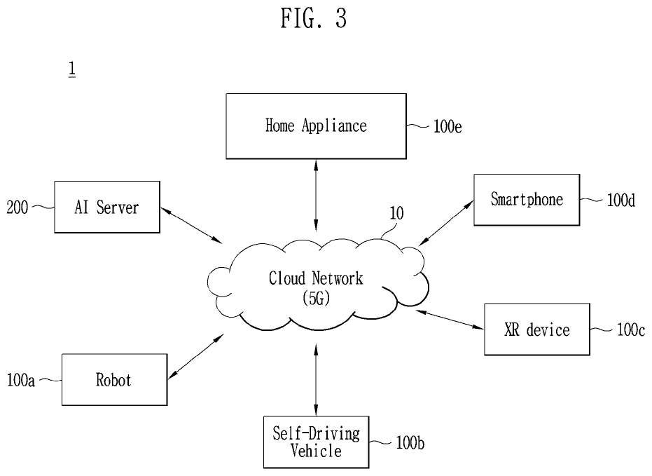

FIG. 3 illustrates an AI system 1 according to an embodiment of the present disclosure.

Referring to FIG. 3, in AI system 1, at least one of AI server 200, a robot 100a , an autonomous driving vehicle 100b , an XR device 100c , a smart phone 100d , and a home appliance 100e is connected to a cloud network 10. Here, robot 100a , autonomous driving vehicle 100b , XR device 100c , smart phone 100d , and home appliance 100e , to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a , autonomous driving vehicle 100b , XR device 100c , smart phone 100d , and home appliance 100e , which are AI devices constituting AI system 1, via cloud network 10, and may assist at least a part of AI processing of connected AI devices 100a to 100e.

At this time, instead of AI devices 100a to 100e , AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e , may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e , to which the above-described technology is applied, will be described. Here, AI devices 100a to 100e illustrated in FIG. 3 may be specific embodiments of AI device 100 illustrated in FIG. 1.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b , but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a predetermined distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b , or may be learned in an external device such as AI server 200.

At this time, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. At this time, autonomous driving vehicle 100b may acquire interactional intention information depending on a user operation or voice expression, and may determine a response based on the acquired intention information to perform an operation.

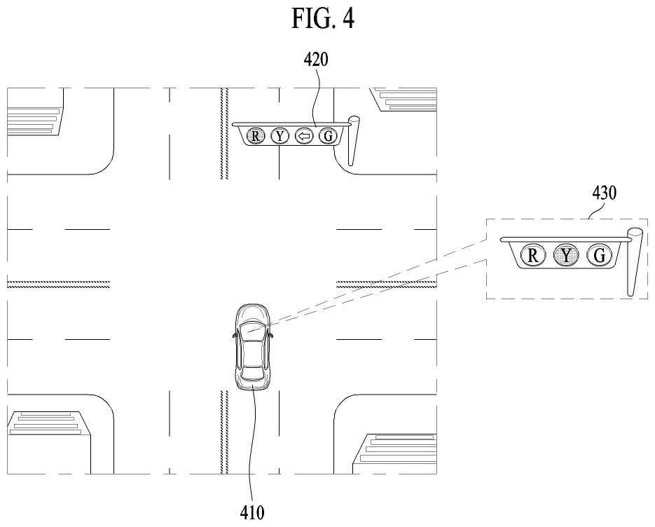

FIGS. 4 to 7 are views illustrating a situation in which the autonomous driving system according to the embodiment of the present invention may determine that it is difficult to autonomously drive utilizing surrounding environment information of the vehicle and traffic signal information.

FIG. 4 is a view illustrating an example in which it is determined that an autonomous driving system according to an embodiment of the present invention is not capable of controlling the driving of the vehicle.

With reference to FIG. 4, an autonomous driving system included in the vehicle 410 may derive surrounding environment information of the vehicle 410 from at least one of the V2X network and the vehicle 410. Here, the V2X network is defined as a generic term for a wireless network between vehicles, a wireless network between a vehicle and an infrastructure, a wired and wireless network in the vehicle, and a network between a vehicle and a mobile terminal. surrounding environment information may include a type of a road on which the current vehicle is located, the number of lanes, a type of traffic lights encountered at the location of the vehicle, and the like. Meanwhile, traffic signal information refers to information about a traffic signal that the current vehicle is predicted to face. For example, traffic signal information may include, but is not limited to, a lighting state of traffic lights encountered by the vehicle, hand signal information of a person who controls traffic on the road, and the like.

In a case of FIG. 4, the autonomous driving system of the vehicle 410 may determine based on surrounding environment information that the current vehicle is located at the intersection and the traffic lights that the vehicle is facing are traffic lights 420 of four-lights traffic signals including a left turn signal. By the way, in a case where it is determined based on traffic signal information that the traffic lights currently encountered by the vehicle 410 are traffic lights 430 of three-lights traffic signals, a type of traffic lights determined based on surrounding environment information and a type of traffic lights determined based on traffic signal information are different to each other, so that the autonomous driving system may determine that it is not possible to control driving with surrounding environment information and traffic signal information.

In addition, also in a case where the autonomous driving system determines based on surrounding environment information that there are provided no traffic lights at the intersection where the current vehicle 410 is located, but determines based on traffic signal information that there are provided traffic lights encountered by the vehicle, the autonomous driving system is not capable of controlling driving with surrounding environment information and traffic signal information.

On the contrary, also in a case where it is determined based on surrounding environment information that there is provided traffic lights on the road where the current vehicle 410 is located, but traffic signal information does not include information on traffic lights predicted to be encountered by the vehicle, the autonomous driving system may display contents for receiving an input of the user.

Similarly, in a case where it is determined based on surrounding environment information that traffics are controlled using a hand signal of a person on the road where the current vehicle 410 is located, but traffic signal information does not include information on the hand signal, the autonomous driving system may determine that it is not possible to control driving with surrounding environment information and traffic signal information.

Also in a case where the autonomous driving system determines based on surrounding environment information and traffic signal information that traffic lights encountered by the current vehicle 410 are in a state of being broken or operation-stopped, the autonomous driving system may determine that it is not possible to control driving by using surrounding environment information and traffic signal information, and may display contents for receiving the input of the user.

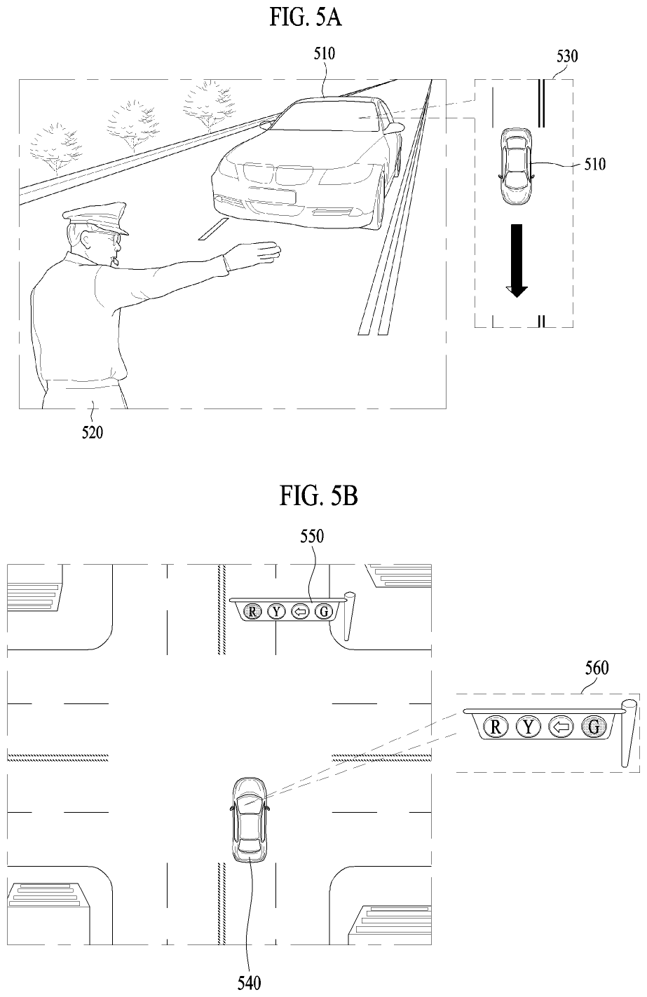

FIGS. 5A and 5B are views illustrating an example in which it is determined that an autonomous driving system according to another embodiment of the present invention is not capable of controlling the driving of the vehicle.

With reference to FIG. 5A, in a case where, although the autonomous driving system recognizes based on surrounding environment information that it is possible to drive straight because there are provided no traffic lights on a road where a current vehicle 510 is located, the autonomous driving system determines through traffic signal information that a person 520 on the road is controlling traffics using a hand signal, this case is regarded as a situation in which it is not possible to control driving with surrounding environment information and traffic signal information.

In addition, with reference to FIG. 5B, in a case where the autonomous driving system of a vehicle 540 determines based on surrounding environment information that the current state of traffic lights 550 faced at the location of the current vehicle 540 is a state where a green light is turned on, but determines based on traffic signal information that the current state of traffic lights 560 that the current vehicle is facing is a state in which a red light is turned on, the autonomous driving system may regard this case as a situation in which it is not possible to control driving with surrounding environment information and traffic signal information.

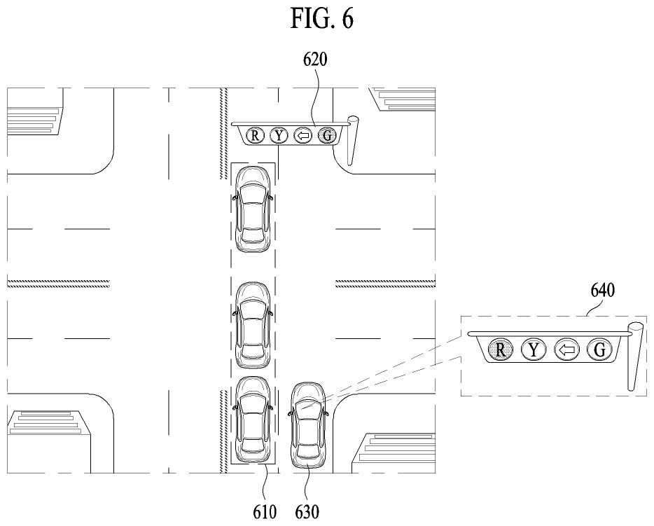

FIG. 6 is a view illustrating an example in which it is determined that an autonomous driving system according to still another embodiment of the present invention is not capable of controlling the driving of the vehicle.

The autonomous driving system according to an embodiment of the present invention may monitor a driving state of the surrounding vehicles through surrounding environment information. With reference to FIG. 6, the autonomous driving system of a vehicle 630 may recognize a state in which the surrounding vehicles 610 drive straight, a state in which a green light of traffic lights 620 encountered by the vehicles 610 is turned on, and the like, based on the surrounding environment information. However, in a case where, based on the received traffic signal information, the autonomous driving system determines a state in which a red light of traffic lights 640 encountered by the current vehicle 630 is turned on, a lighting state of the traffic lights determined based on surrounding environment information and a lighting state of the traffic lights determined based on traffic signal information are different to each other, so that the autonomous driving system is not capable of controlling driving with surrounding environment information and traffic signal information.

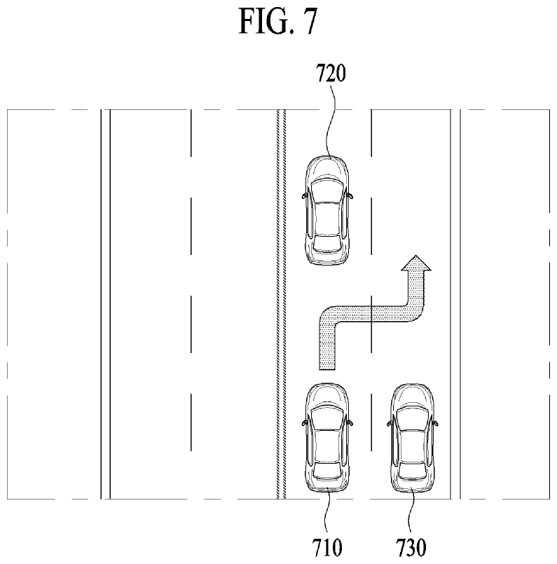

FIG. 7 is a view illustrating an example in which it is determined that an autonomous driving system according to still other embodiments of the present invention is not capable of controlling the driving of the vehicle.

In addition to cases illustrated in FIGS. 4 to 6, in a case where the determination of the driving control of the autonomous driving system is delayed, the autonomous driving system according to an embodiment of the present invention may generate a driving control signal based on an input of the user.

With reference to FIG. 7, in a case where the vehicle 710 keeps driving at a speed lower than that of the surrounding vehicle 730 due to the preceding vehicle 720, the autonomous driving system may determine that it is needed to make a lane change. However, in a case where the autonomous driving system performs control such that a vehicle 710 still drives at a speed lower than that of the surrounding vehicle 730 behind the preceding vehicle 720 without making the lane change even over a predetermined time period, the autonomous driving system may display contents for receiving an input of a user and generate a vehicle control signal based on the input of the user.

In addition, in a case where it is determined based on surrounding environment information that the vehicle is waiting for a right turn, a branch, a merging, a left turn with no left-turn signal, an entry or exit at a roundabout, and the like, the autonomous driving system may generate a vehicle control signal after receiving the input of the user, when the vehicle does not make a right turn, branch, merges, make a left turn with no left-turn signal, enter into or exit from the roundabout even over a predetermined time period.

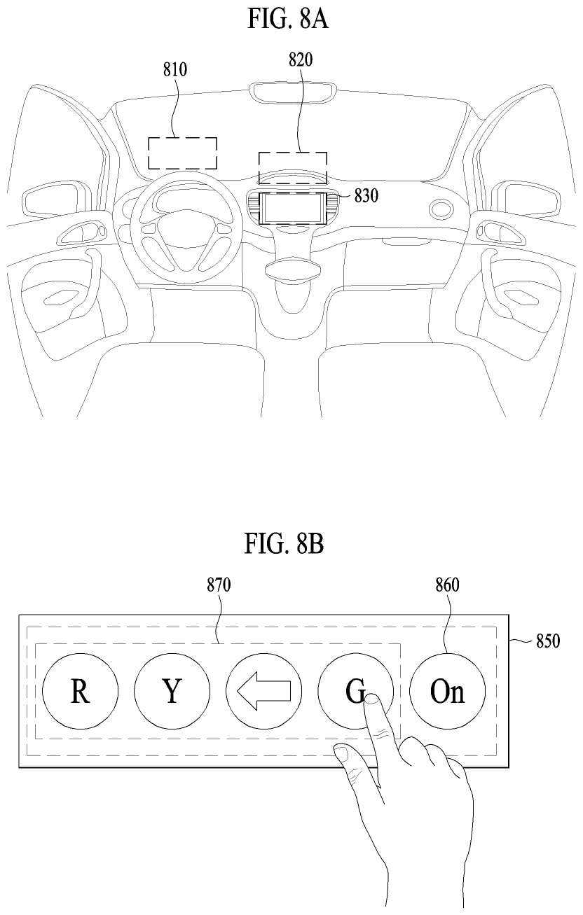

FIGS. 8A and 8B are views illustrating an example in which an autonomous driving system according to an embodiment of the present invention receives an input of a user.

FIG. 8A is a view displaying a location inside a vehicle, in which the autonomous driving system may display contents for receiving an input of a user.

With reference to FIG. 8A, the autonomous driving system may display the contents on a windshield 810, a dashboard 820, a navigation system 830, and the like of the vehicle, but an area in which contents are displayed is not limited thereto. It will be apparent to those skilled in the art that the contents may be displayed at any location inside the vehicle for the convenience of the user.

FIG. 8B is a view in which the autonomous driving system displays contents for receiving the input of the user.

The autonomous driving system may display contents 850 for receiving the input of the user in areas 810, 820, and 830 inside the vehicle illustrated in FIG. 8A. Here, the contents 850 for receiving the input of the user is determined based on surrounding environment information, and may be contents corresponding to traffic lights that the vehicle is facing.

With reference to FIG. 8B, in a case where the autonomous driving system determines through surrounding environment information that traffic lights, which may be encountered by the vehicle on the road where the vehicle is located, are traffic lights of four-lights traffic signals, the autonomous driving system may display traffic lights 870 of four-lights traffic signals to the user, and cause the user to perform an input after checking a lighting state of the current traffic lights.

Meanwhile, the contents 850 for receiving the input of the user may be contents corresponding to driving and stop control signals of the vehicle. For example, the autonomous driving system may display a button 860 corresponding to a straight-driving control signal, to allow the user to control the straight-driving of the vehicle. Meanwhile, although only the straight-driving button 860 is displayed in FIG. 8B, it is possible to additionally display a driving-stop button, and it will be apparent to those skilled in the art that the straight-driving button 860 and the driving-stop button may be displayed together similarly to a switch.

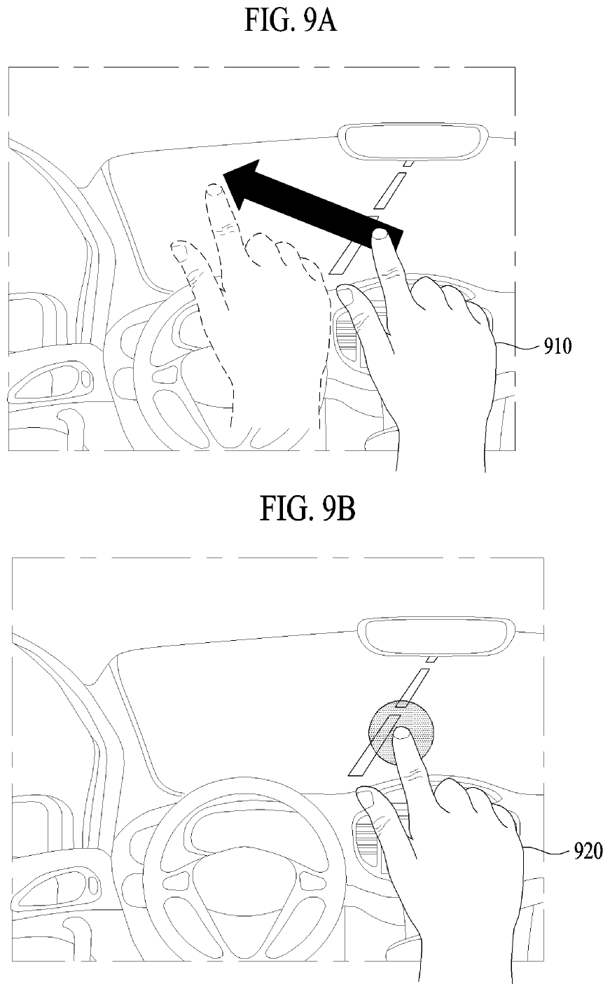

FIGS. 9A and 9B are views illustrating an example in which an autonomous driving system according to another embodiment of the present invention receives an input of a user.

The contents for receiving the input of the user according to an embodiment of the present invention may be contents associated with a lane, in which the vehicle is driving, and a surrounding lane.

With reference to FIG. 9A, in a case where a user takes a dragging gesture toward a specific lane, the autonomous driving system may receive a gesture input 910 of the user and generate a driving control signal such that a lane change to the corresponding lane may be made.

In addition, with reference to FIG. 9B, in a case where the user touches an area corresponding to a specific lane on the display, the autonomous driving system may receive a touch input 920 of the user and generate a driving control signal such that a lane change to the corresponding lane may be made.

In a case where it is determined based on surrounding environment information that the vehicle is driving on the road with no traffic lights, the autonomous driving system may display button-shaped contents according to the number of lanes of the road on which the vehicle is driving, based on surrounding environment information, and receive the input of the user. In addition, also in a case where a hand signal is received as traffic signal information, the autonomous driving system may display button-shaped contents according to the number of lanes of the road on which the vehicle is driving, and receive the input of the user.

In a case where the input of the user is received, the autonomous driving system according to an embodiment of the present invention may generate a driving control signal of the vehicle based on the input of the user, surrounding environment information, and traffic signal information.

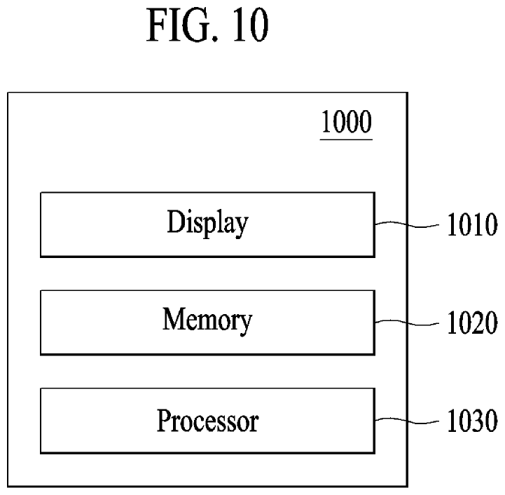

FIG. 10 is a block diagram of an autonomous driving system according to an embodiment of the present invention.

An autonomous driving system 1000 according to an embodiment may include a display 1010, a memory 1020, and a processor 1030.

The memory 1020 may store the surrounding environment information of the vehicle and the traffic signal information that the vehicle is predicted to have faced.

The display 1010 may include at least one of a plurality of displays that are attached to components inside the vehicle, such as a Head Up Display (HUD), a windshield and window of the vehicle, or are included inside the vehicle, such as the navigation system, and may display contents for receiving the input of the user.

Here, the contents for receiving the input of the user may be determined based on surrounding environment information, and include contents corresponding to the traffic lights that the vehicle is facing. In addition, the contents for receiving the input of the user may include contents corresponding to the driving and stop control signals of the vehicle, and contents associated with the lane, in which the vehicle is driving, and a surrounding lane. At this time, the input of the user may include a gesture input, a touch input, and the like.

Meanwhile, the display 1010 may include a transparent display having predetermined transparency and displaying contents for receiving the input of the user.

In order to have transparency, the transparent display may include at least one of a transparent Thin Film Electroluminescent (TFEL), a transparent Organic Light-Emitting Diode (OLED), a transparent Liquid Crystal Display (LCD), a transmissive transparent display, and a transparent Light Emitting Diode (LED), and the transparency of the transparent display may be adjusted.

The processor 1030 may derive surrounding environment information of a vehicle and traffic signal information based on data received from at least one of a V2X network and a vehicle sensor, determine whether or not it is possible to control driving of the vehicle by utilizing surrounding environment information and traffic signal information, control the display 1010 such that contents for receiving an input of a user are displayed on the display 1010, and generate a driving control signal of the vehicle based on the input of the user, surrounding environment information, and traffic signal information.

In addition, the determination by the processor 1030 on whether or not it is possible to control driving of the vehicle may include determining that it is not possible to control driving of the vehicle, in a case where a type of traffic lights, on the road where the vehicle is driving, included in the surrounding environment information and a type of traffic lights included in traffic signal information are different to each other.

In addition, the determination by the processor 1030 on whether or not it is possible to control driving of the vehicle may include determining that it is not possible to control driving of the vehicle, in a case where driving information of a surrounding vehicle included in the surrounding environment information does not match a lighting state of traffic lights included in the traffic signal information.

In addition, the determination by the processor 1030 on whether or not it is possible to control driving of the vehicle may include determining that it is not possible to control driving of the vehicle, in a case where traffic lights on the road where the vehicle is driving, included in the surrounding environment information, is in a state of being broken, or there are provided no traffic lights on the road where the vehicle is driving.

In addition, the determination by the processor 1030 on whether or not on whether or not it is possible to control driving of the vehicle may include determining that it is not possible to control driving of the vehicle, in a case where a lane, in which the vehicle is drivable, determined through surrounding environment information and a lane, in which the vehicle is drivable, determined through traffic signal information are different to each other.

In addition, the determination by the processor 1030 on whether or not it is possible to control driving of the vehicle may include determining that it is not possible to control driving of the vehicle, in a case where autonomous driving is continued under the same condition over a predetermined time period while the vehicle is driving autonomously.

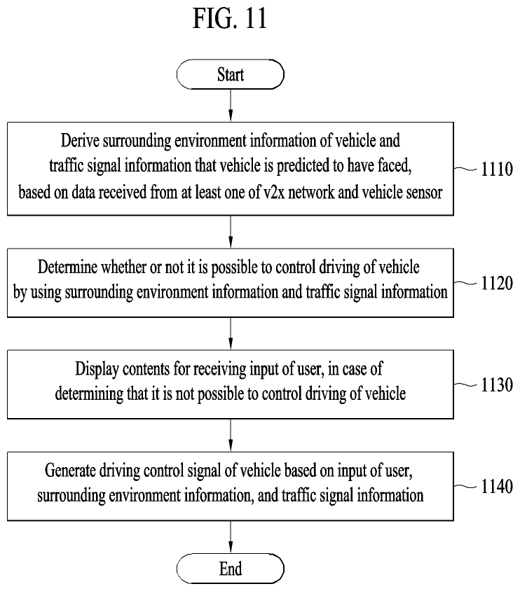

FIG. 11 is a flowchart illustrating an autonomous driving method according to an embodiment of the present invention.

In step 1110, the autonomous driving system may derive surrounding environment information of a vehicle and traffic signal information that the vehicle is predicted to have faced, based on data received from at least one of the V2X network and the vehicle sensor.

In step 1120, the autonomous driving system may determine whether or not it is possible to control driving of the vehicle by utilizing surrounding environment information and traffic signal information.

Here, step 1120 may include determining that it is not possible to control driving of the vehicle, in a case where a type of traffic lights, on the road where the vehicle is driving, included in the surrounding environment information and a type of traffic lights included in the traffic signal information are different to each other.

In addition, in step 1120, it may be determined that it is not possible to control driving of the vehicle, in a case where the driving information of a surrounding vehicle included in the surrounding environment information does not match a lighting state of traffic lights included in the traffic signal information.

In addition, in step 1120, it is determined that it is not possible to control driving of the vehicle, in a case where it is determined that traffic lights on the road where the vehicle is driving, included in the surrounding environment information, is in a state of being broken, or there are provided no traffic lights on the road where the vehicle is driving.

In addition, in step 1120, it may be determined that it is not possible to control driving of the vehicle, in a case where a lane, where the vehicle is drivable, determined through surrounding environment information and a lane, where the vehicle is drivable, determined through traffic signal information are different to each other.

In addition, in step 1120, it may be determined that it is not possible to control driving of the vehicle, in a case where driving is continued under the same condition over a predetermined time period after a change in surrounding environment information is detected while the vehicle is driving autonomously.

In step 1130, in a case where it is determined that it is not possible to control driving of the vehicle, the autonomous driving system may display contents for receiving an input of a user.

In step 1140, the autonomous driving system may generate a driving control signal of the vehicle based on the input of the user, the surrounding environment information, and the traffic signal information.

Although the exemplary embodiments of the present disclosure have been described in this specification with reference to the accompanying drawings and specific terms have been used, these terms are used in a general sense only for an easy description of the technical content of the present disclosure and a better understanding of the present disclosure, and are not intended to limit the scope of the present disclosure. It will be clear to those skilled in the art that, in addition to the embodiments disclosed here, other modifications based on the technical idea of the present disclosure may be implemented.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An autonomous driving method comprising:
deriving surrounding environment information of a vehicle and traffic signal information that the vehicle is predicted to have faced, based on data received from at least one of a V2X network and a vehicle sensor;
determining whether or not it is possible to control driving of the vehicle by utilizing the surrounding environment information and the traffic signal information;
displaying contents for receiving an input of a user, in a case where it is determined that it is not possible to control driving of the vehicle; and
generating a driving control signal of the vehicle based on the input of the user, the surrounding environment information, and traffic signal information.

2. The method of claim 1, wherein the determining whether or not it is possible to control driving of the vehicle includes
determining that it is not possible to control driving of the vehicle, in a case where a type of traffic lights, on the road where the vehicle is driving, included in the surrounding environment information and a type of traffic lights included in traffic signal information are different to each other.

3. The method of claim 1, wherein the determining whether or not it is possible to control driving of the vehicle includes
determining that it is not possible to control driving of the vehicle, in a case where driving information of a surrounding vehicle included in the surrounding environment information does not match a lighting state of traffic lights included in the traffic signal information.

4. The method of claim 1, wherein the determining whether or not it is possible to control driving of the vehicle includes
determining that it is not possible to control driving of the vehicle, in a case where it is determined that traffic lights on the road where the vehicle is driving, included in the surrounding environment information, is in a state of being broken, or there are provided no traffic lights on the road where the vehicle is driving.

5. The method of claim 1, wherein the traffic signal information includes hand signal information, and
the determining whether or not it is possible to control driving of the vehicle includes
determining that it is not possible to control driving of the vehicle, in a case where a lane, in which the vehicle is drivable, determined through the surrounding environment information and a lane, in which the vehicle is drivable, determined through the traffic signal information are different to each other.

6. The method of claim 1, wherein the determining whether or not it is possible to control driving of the vehicle includes determining that it is not possible to control driving of the vehicle, in a case where driving is continued under the same condition over a predetermined time period after a change in surrounding environment information is detected while the vehicle is driving autonomously.

7. The method of claim 1, wherein contents for receiving the input of the user is determined based on the surrounding environment information and includes contents corresponding to traffic lights that the vehicle is facing.

8. The method of claim 1, wherein contents for receiving the input of the user is associated with a lane, in which the vehicle is driving, and a surrounding lane.

9. The method of claim 1, wherein contents for receiving the input of the user includes contents corresponding to driving and stop control signals of the vehicle.

10. The method of claim 1, wherein the input of the user includes at least one of a gesture input and a touch input.

11. An autonomous drive system comprising:
a display configured to display contents for receiving an input of a user;
a memory configured to store surrounding environment information of a vehicle and traffic signal information that the vehicle is predicted to have faced; and
a processor configured to derive the surrounding environment information of the vehicle and the traffic signal information, based on data received from at least one of a V2X network and a vehicle sensor, to determine whether or not it is possible to control driving of the vehicle by utilizing the surrounding environment information and the traffic signal information, to control the display such that contents for receiving an input of a user are displayed on the display, in a case where it is determined that it is not possible to control driving of the vehicle, and to generate a driving control signal of the vehicle based on the input of the user, the surrounding environment information, and traffic signal information.

12. The autonomous drive system of claim 11, wherein determination on whether or not it is possible to control driving of the vehicle, includes
determining that it is not possible to control driving of the vehicle, in a case where a type of traffic lights, on the road where the vehicle is driving, included in the surrounding environment information and a type of traffic lights included in traffic signal information are different to each other.

13. The autonomous drive system of claim 11, wherein determination on whether or not it is possible to control driving of the vehicle, includes
determining that it is not possible to control driving of the vehicle, in a case where driving information of a surrounding vehicle included in the surrounding environment information does not match a lighting state of traffic lights included in the traffic signal information.

14. The autonomous drive system of claim 11, wherein determination on whether or not it is possible to control driving of the vehicle, includes
determining that it is not possible to control driving of the vehicle, in a case where it is determined that traffic lights on the road where the vehicle is driving, included in the surrounding environment information, is in a state of being broken, or there are provided no traffic lights on the road where the vehicle is driving.

15. The autonomous drive system of claim 11, wherein the traffic signal information includes hand signal information, and
determination on whether or not it is possible to control driving of the vehicle, includes
determining that it is not possible to control driving of the vehicle, in a case where a lane, in which the vehicle is drivable, determined through the surrounding environment information and a lane, in which the vehicle is drivable, determined through the traffic signal information are different to each other.

16. The autonomous drive system of claim 11, wherein determination on whether or not it is possible to control driving of the vehicle, includes
determining that it is not possible to control driving of the vehicle, in a case where autonomous driving is continued under the same condition over a predetermined time period while the vehicle is driving autonomously.

17. The autonomous drive system of claim 11, wherein contents for receiving the input of the user is determined based on the surrounding environment information and includes contents corresponding to traffic lights that the vehicle is facing.

18. The autonomous drive system of claim 11, wherein contents for receiving the input of the user is associated with a lane, in which the vehicle is driving, and a surrounding lane.

19. The autonomous drive system of claim 11, wherein contents for receiving the input of the user includes contents corresponding to driving and stop control signals of the vehicle.

20. A computer-readable recording medium that records a method for executing the method of claim 1 on a computer.
